(19) United States
(12) Patent Application Publication
(10) Pub. No.: US 2006/0024476 A1
(43) Pub. Date: Feb. 2, 2006

(54) Method of marking a skin for a vehicle interior panel

(76) Inventors: Richard Leland, South Berwick, ME (US); John D. Gray, Union, NH (US)

Correspondence Address: GROSSMAN, TUCKER, PERREAULT & PFLEGER, PLLC, 55 SOUTH COMMERICAL STREET, MANCHESTER, NH, 03101, US

(21) Appl. No.: 11/054,035

(22) Filed: Feb. 8, 2005

Related U.S. Application Data
(63) Continuation-in-part of application No. 10/033,437, filed on Dec. 28, 2001.
Application No. 10/033,437 is a division of application No. 09/625,117, filed on Jul. 25, 2000, now Pat. No. 6,371,548.

(51) Int. Cl. B32B 3/10

(52) U.S. Cl. 428/137; 264/446; 264/482; 428/172

(57) ABSTRACT

A method of marking a skin for a vehicle interior trim panel comprising providing a skin with a color and an outer surface. A laser is applied to the outer surface such that a portion of the skin surface contacted by the laser changes color relative to a portion of the outer skin not contacted by the laser to create a marking in the outer skin surface indicating the presence of a vehicle component or function. In particular, an image, pattern, or color contrast may be created on the skin. A unique hole pattern and size distribution caused by the laser may provide a skin with a woven fabric texture. In addition, stitches formed on a skin surface may be colored differently from the surrounding skin surface to distinguish their appearance.

### CROSS-REFERENCE TO RELATED APPLICATIONS

This application is a continuation-in-part of U.S. patent application Ser. No. 0/033,437, filed Dec. 28, 2001, which is a divisional application of U.S. patent application Ser. No. 09/625,117, filed Jul. 25, 2000.

### TECHNICAL FIELD OF THE INVENTION

This invention relates generally to the method of marking a skin for a vehicle interior trim panel. More particularly, this invention relates to surface decoration of automotive trim components, in particular using a laser to create an image, pattern or color contrast. The decoration may be merely a color change in the area irradiated by the laser or may be an engraving into the surface due to melting or ablation of the polymer, or a combination of both. More specifically, the present invention relates to the laser treatment of a cast plastic surface with a unique hole pattern and size distribution to provide the appearance of woven fabric texture. In addition, stitches and accent lines formed in the skin of the component may be decorated in a contrasting color by the laser to distinguish their presence.

### BACKGROUND OF THE INVENTION

U.S. Pat. No. 4,904,429 recites a method of producing an instrument panel of a motor vehicle or similar molding of foamed resin capable of fitting electrical parts thereon as desired. More particularly, the '429 patent recites a method of producing a molding of foamed resin in which a flexible printed circuit (FPC), which is electrically connectable to electrical parts, is buried. The '429 patent also recites that an instrument panel has customarily been implemented as a laminate having three layers, i.e., a covering made of soft resin, a base made of ABS resin or similar hard resin, and a padding made of foamed urethane or similar foaming resin and sandwiched between the covering and the base, and that an FPC and couplers are each mounted on the base by using adhesive or screws. Continuing, the '429 patent recites that such a prior art three-layer instrument panel, however, is not satisfactory because the base and the padding have to be produced independently of each other and then bonded together, resulting in a disproportionate production cost.

As an alternative to the prior art three-layer instrument panel described by the '429 patent, the '429 patent recites that the base may be formed from a foamed resin and molded integrally with the padding. However, when the base is formed from a foamed resin, the '429 patent then discloses that the FPC and couplers may not be mounted with screws or adhesives. Consequently, the '429 patent proposes a solution for mounting the FPC and couplers to this alternative structure by burying the FPC and couplers in the base when the latter is molded.

In light of the '429 patent, what is needed is a structure and method of combining a flat wire with a three-layer interior trim panel without the need for separate fasteners, such as screws, or adhesives and indicating the presence of that wire on the top surface of the panel.

With the competition between the large number of motor vehicle manufacturers globally, product differentiation is crucial to commercial success. Generally, the major emphasis is on vehicle exterior design, however, within competing vehicle segments and with the much greater role that interior design plays today in vehicle selection, differentiation of the vehicle's interior components has become increasingly important.

Numerous general means are currently in use to decorate either interior, exterior or other vehicle components. Such techniques broadly range from texture or graining or lettering formed or embossed in or on a surface, to stitching (both actual or simulated), hot stamping, pad printing, multi-color/dual shot injection molding, powder casting and painting.

With interior trim components, it is desirable to have trademarks, logos, identification of features, instructions, icons, figures, numbers or other indicia to distinguish the vehicle or to ease the driving experience. Currently, there are numerous means to accomplish this end, albeit expensive and environmentally challenging. In most of these cases, the process for providing the distinguishing mark or contrast requires the addition of a material such as paint or a second layer to the surface of the trim components. These components are generally of plastic and formed by injection molding, casting, compression molding, blow molding, extrusion and similar processes.

For instance, painting is a popular means to decorate a trim component surface to affect gloss level, color combination or even texture. Unfortunately, it is an expensive option as it adds labor, material, cycle time (to dry), energy costs and waste management/environmental issues (overspray, emissions, disposal). Alternatively, hot stamping, in which a roll leaf is stamped with heated metal dies onto a plastic surface, can provide a multi-colored image, however it is not useful on a flexible surface and uses expensive tooling (printing plate) and equipment.

Pad printing is an alternate method of surface decoration where a base coat, a printed ink layer and a topcoat are sequentially applied. Similar to the previous referenced painting process, there are environmental disadvantages due to the use of solvents. In addition, there are numerous steps and time added to the manufacturing process and, there is always a possibility of the coating being worn through during the useful life of the component.

There are, of course, reports on the use of multi-colored resins which can be molded to form contrasting colors as well. Two-shot injection molding of thermoplastic resins having different colors and dual casting of two different colors of powder are reported in various automotive applications.

More specifically, U.S. Pat. Nos. 5,316,715; 5,225,261; 5,225,214; 5,093,066; 5,074,733; 5,046,941; 5,033,954; 4,938,906; 4,925,151; 4,895,690; and 4,610,620 all commonly assigned to the assignee of the present invention, describe some of these decorative processes and are hereby incorporated herein by reference. In addition, U.S. Pat. Nos. 5,571,597 and 5,439,630, also commonly assigned to the assignee of the present invention and hereby included herein by reference, focus on texture and stitching in thin-walled plastic shells in an attempt to simulate leather and provide surface decoration and differentiation.

Further, features such as numbers or letters in relief on the surface can be cast in different colors as disclosed in U.S. Pat. Nos. 5,073,325; 4,938,906; 4,919,069 and 4,894,004, again commonly assigned to the assignee of the present invention and hereby included herein by reference.

More recently, laser marking of plastics has become an emerging field. U.S. Pat. No. 5,792,807, entitled “Composition Adaptable of Suitable for Being Marked and Molded Thereof”, assigned to Nippon Kayaka Kabushiki Kaisha, discloses a marking composition consisting of polyolefin and calcium carbonate which forms a white mark upon irradiation with a laser beam.

Attention is also directed to U.S. Pat. Nos. 6,168,853; 6,118,096; 6,022,905; 6,017,972; 5,977,514; and 5,976,411 which are directed at controlled laser marking of plastic. For instance, the '905 patent discloses a laser-marked molded plastic article comprising a thermoplastic resin, laser-energy absorbing additive and two color pigments as well as a technique of laser marking. These references generally require an additive which can absorb energy from the laser, a pigment capable of changing color, a phosphorescent pigment, or some combination thereof.

Attention is directed to U.S. Pat. No. 6,284,184 B 1 assigned to Avaya Technology Corp., which discloses a mixture of two polymers of differing density where the lower density polymer forms the outer surface of the molding. The outer layer is subsequently removed by ablation with a laser in the desired design to expose a different colored higher density polymer underneath.

Use of a laser to form a row of holes or perforations defining a preweakened area or tear seam in an air bag cover for a motor vehicle is known. Primarily these perforations are made on the underside of the cover skin and extend only part way through the thickness of the skin so as not to be perceptible on the front surface. Generally, only one row or two staggered rows of holes are used to ensure a clean tear line. U.S. Pat. Nos. 5,632,914; 5,992,876 and 5,961,143, commonly assigned to the assignee of the present invention and hereby included herein by reference disclose examples of laser perforation for this purpose.

In addition, apparatus and processes for laser perforating are described in U.S. Pat. No. 6,294,124 B1 and U.S. Pat. No. 5,883,356 to TIP Engineering Group, Inc.; U.S. Pat. No. 6,337,461 B1 to Sanko Gosei UK Ltd.; U.S. Pat. No. 5,882,572 to Jenoptik Aktiengesellschaft and U.S. Pat. No. 6,365,869 B1 to Matsushita Electric Industrial Co.

Upon review of the above, it becomes clear that what is needed is a simple, relatively low cost method of providing distinguishing marks and color features on the surface of automotive trim interior and exterior components, which more efficiently makes use of laser technology and which provides patterns, decoration or surface texture not previously disclosed in the art.

### SUMMARY OF THE INVENTION

Accordingly, the present invention provides a structure and a method for combining a flat wire with a three-layer instrument panel without the need for separate fasteners, such as screws, or adhesives.

According to one feature of the invention, a vehicle interior trim panel is provided comprising a skin, a substrate, a foam located between the skin and the substrate, and a flat wire at least partially surrounded by and embedded in the foam. The wire herein is therefore either physically placed within the foam, or, in the alternative, chemically bonded to the foam material.

According to another feature of the invention, the flat wire comprises a flexible printed circuit.

According to another feature of the invention, a terminal end of the flat wire may include a connector.

According to another feature of the invention, the foam comprises a density between 0.016 g/cm.sup.3 to 0.288 g/cm.sup.3.

According to another feature of the invention, the foam comprises an ultimate elongation greater than five percent.

According to another feature of the invention, the substrate comprises a substrate aperture and the flat wire passes though the aperture.

According to another feature of the invention, the substrate comprises at least a portion of a flat wire holder.

According to another feature of the invention, the substrate portion of the flat wire holder is formed with the substrate and is adjacent the inner substrate surface.

According to another feature of the invention, the flat wire holder at least partially confines movement of the flat wire.

According to another feature of the invention, the flat wire holder comprises an elongated recess for holding or confining a terminal end of the flat wire with a smaller width dimension or a smaller length dimension than the terminal end of the flat wire.

According to another feature of the invention, the flat wire holder comprises a pocket for holding or confining at least a portion of the flat wire, and at least a portion of the pocket comprises a recess formed in the substrate.

According to another feature of the invention, the foam at least partially enters into the substrate aperture and the foam surrounds at least a portion of the flat wire.

According to another feature of the invention, the foam entering into the substrate aperture is a buffer between the flat wire and a surface of the substrate aperture.

According to another feature of the invention, the foam entering into the substrate aperture reduces contact, noise and wear between the flat wire and a surface of the substrate aperture.

According to another feature of the invention, the foam exiting from the substrate aperture surrounds at least a portion of the flat wire, prevents the flat wire from being displaced from an embedded position and reduces contact between the flat wire and a corner of the substrate aperture.

According to another feature of the invention, the terminal end of the flat wire is moved from a first position to a second position.

According to another feature of the invention, a method of making a vehicle interior trim panel comprises providing a substrate, providing a skin, routing a flat wire along a surface of the substrate and through a substrate aperture, and providing a foam between the skin and the substrate such that the foam at least partially surrounds and embeds a portion of the flat wire.

Acording to another feature of the invention, the method of making a vehicle interior trim panel further comprises the foam entering at least a portion of the substrate aperture between the flat wire and at least one substrate aperture surface.

Acording to another feature of the invention, the method of making a vehicle interior trim panel further comprises the foam exiting the substrate aperture between the flat wire and at least one substrate aperture surface.

Acording to another feature of the invention, the method of making a vehicle interior trim panel further comprises at least partially confining the flat wire in a pocket and adjacent the substrate inner surface.

According to another feature of the invention, the method of making a vehicle interior trim panel further comprises at least partially confining the terminal end of the flat wire in an elongated recess and adjacent the substrate inner surface.

According to another feature of the invention, a method of marking a skin for a vehicle interior trim panel comprises providing a skin with a color and an outer skin surface, and applying a laser to the outer skin surface such that a portion of the skin surface contacted by the laser changes color relative to a portion of the outer skin surface not contacted by the laser to create a marking in the outer skin surface indicating the presence of a vehicle component or function. The markings may be of any design, including but not limited to, logos, accent lines, stitches, scripts, icons, instructions and other indicia.

According to another feature of the present invention, a plastic interior trim panel having a surface upon which one or more imitation stitches or one or more accent lines are formed is provided, said surface of a first color, wherein one or more of said stitches or accent lines are colored a second color different from the surface of said article by the irradiation of a laser upon said stitches or accent lines.

According to another feature of the present invention, a method of coloring imitation stitches or accent lines formed on the surface of an interior panel is provided, comprising the steps of forming the interior panel including a surface, wherein imitation stitches or accent lines are formed on the surface, irradiating one or more of the stitches or one of more of the accent lines with a laser to change the color of said stitches.

A laser-marked molded, extruded or formed plastic article having a thickness and a viewing surface is also provided, the article comprising holes or lines created part-way through the thickness of the article on the viewing surface, said holes located in both an “x” and “y” direction on said viewing surface, said holes having a depth “z: of up to about 50% of the thickness of the article, wherein said pattern of holes in the “x” and “y” direction each comprise two or more rows of tapered holes, and said tapered holes having a diameter of from 0.0100″ to 0.0300″ at the viewing surface. The holes are generally round in shape but may also be square, oval, diamond shaped, etc. By varying laser parameters, lines may be formed rather than holes to provide a means for engraving the viewing surface.

### BRIEF DESCRIPTION OF THE DRAWINGS

To better understand and appreciate the invention, refer to the following detailed description in connection with the accompanying drawings:

FIG. 1 is a perspective view of an interior trim panel electrical switch assembly according to the present invention;

FIG. 2 is a cross sectional view of the switch of the interior trim panel electrical switch assembly of FIG. 1 taken along section line 2-2;

FIG. 3 is a cross sectional view of the wire of the interior trim panel electrical switch assembly of FIG. 1 taken along section line 3-3;

FIG. 4 is a cross sectional view of the trim panel of FIG. 1 in a foam mold prior to introducing foam material taken along section line 4-4 according to a second embodiment of the present invention;

FIG. 5 is a cross sectional view of the trim panel and electrical device of FIG. 1 taken along section line 4-4 according to the second embodiment of the present invention.

FIG. 6 is a perspective view of a cast sheet of thermoplastic urethane (TPU) stock decorated using a YAG laser according to the claimed invention.

FIG. 7 is a perspective view of a cast sheet of polyvinylchloride (PVC) alloy stock decorated using a YAG laser according to the claimed invention.

FIG. 8 is a perspective view of a cast sheet of thermoplastic olefin (TPO) stock engraved with various hole patterns using a CO₂ laser according to the claimed invention.

FIG. 9 is a perspective view of a cast sheet of polyvinylchloride (PVC) alloy stock engraved with a CO₂ laser to produce a fabric appearance according to the claimed invention.

FIG. 10 is a perspective view of a section of an airbag door cover with a preweakened tear seam on the top surface according to the claimed invention.

FIG. 11 is a photograph of the magnified surface or one hole pattern of FIG. 8.

FIG. 12 is a plot of amperage vs. frequency for a YAG laser showing various levels of color change.

FIGS. 13A and 13B are perspective views of a vehicle interior panels wherein formed stitches have been colored differently from the surrounding surface, according to the present invention.

### DETAILED DESCRIPTION OF THE INVENTION

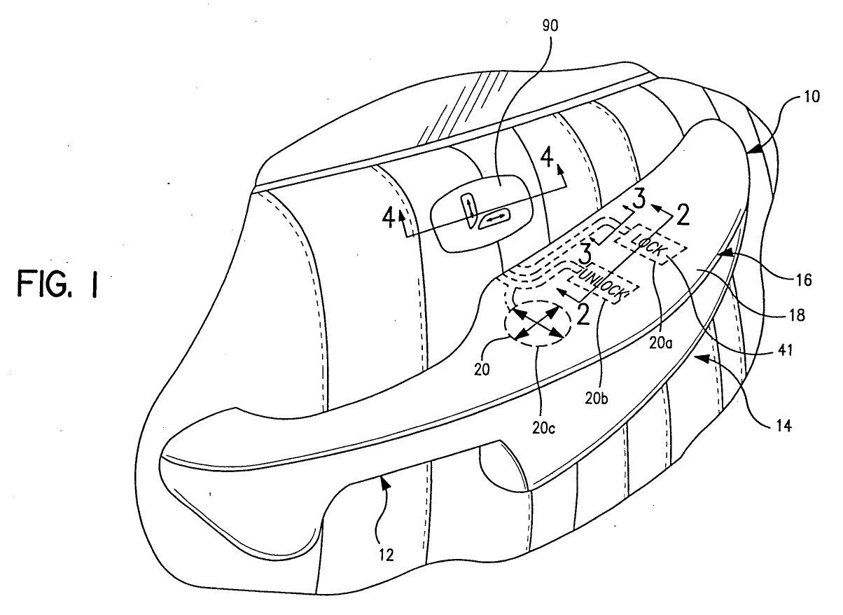

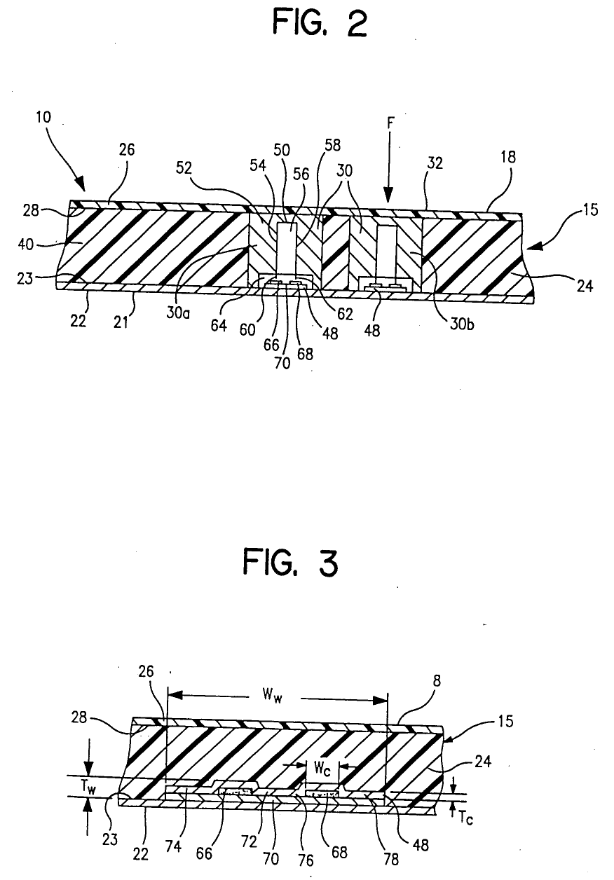

An exemplary vehicle interior trim panel electrical switch assembly of the type for actuating various vehicle electrical devices is shown at 10 in FIG. 1 in connection with an armrest 12 for a vehicle trim panel 14, such as a door panel. As shown in FIGS. 1 and 2, the armrest 12 is formed as a soft feel composite 15 which includes a switch panel portion 16 that has an outer surface 18 covering a switch array 20 including three electrical switches indicated at 20a-20c. Two of the three electrical switches may be for locking and unlocking the doors of the vehicle while the remaining switch may be a multiposition switch for adjusting the position of the side view mirror. Other switches not shown may include, but are not limited to, switches for opening and closing windows, seat adjustment and for selecting either the left or the right side view mirror for adjustment.

The armrest 12 is shown as a separate member from the trim panel 14, but the armrest and trim panel 14 could be formed as one integral interior trim panel. Furthermore, the vehicle interior trim panel electrical switch assembly 10 can be employed on any interior surface of any trim panel in the vehicle. For example, it can be part of the instrument panel, headliner, overhead console, seats or any other part of a vehicle interior.

Additionally, the switch array 20 can vary in number and location. For example, in another application a single switch can be provided to operate an overhead light, a power operated sunroof or other electrically switched accessory on a motor vehicle. Other arrangements will depend upon the system being controlled by the switch array 20 underlying the switch panel portion 16.

As shown in FIG. 2, the soft feel composite 15 and switch panel portion 16 of the interior trim panel electrical switch assembly 10 comprises a substrate layer 22, a foam layer 24, and a skin layer 26. The outer surface 18 of skin layer 26 is the surface generally viewed by a vehicle occupant and is preferably continuous between the soft feel composite 15 and switch panel portion 16 of trim panel 14. Generally, foam layer 24 is bonded directly to outer surface 23 of substrate layer 22 and to inner surface 28 of skin layer 26.

A switch 30 and a wire 48 are located beneath outer surface 18 within the switch panel portion 16 of the interior trim panel electrical switch assembly 10. Preferably, the switch 30 has a low profile which allows it to be easily incorporated under outer surface 18 of skin layer 26 of the switch panel portion 16. As used in this specification, a low profile switch has a thickness less than or equal to that of foam layer 24. In other words, a thickness less than or equal to the distance as measured between the inner surface 28 of skin layer 26 and outer surface 23 of substrate layer 22. More preferably, the switch 30 provides a substantially flat or arcuate surface region 32 in outer surface 18 of skin layer 26 without any bumps, ridges or other disruptions in outer surface 18. However, it is recognized that certain disruptions in the outer surface 18 may be desirable as to provide assistance in locating switch panel portion 16 in an environment of reduced light or when it is unsafe for the driver to remove his vision from the road for the purposes of locating switch panel 16.

Switch 30 preferably comprises a switch arm 50 disposed within a housing portion 52. Switch arm 50 functions as a conductor and preferably comprises a metal such as copper. In the illustrated exemplary embodiment, switch arm 50 is preferably U-shaped and comprises elongated member 54 connected to elongated member 58 by connecting member 56. Preferably connecting member 56 is completely embedded in housing 52 which functions as an insulator while elongated member 54 and elongated member 58 are only partially embedded within housing portion 52 with contact portions 60 and 62 respectively thereof remaining exposed. Preferably, housing portion 52 comprises a polymer material and more preferably the polymer material comprises a silicone polymer.

Preferably, housing 52 also comprises a recessed cavity 64 into which contact portions 60 and 62 of elongated members 54 and 58 project into. Recessed cavity 64 also preferably contains a wire 48. Wire 48 comprises conductors 66 and 68 as well as an insulator 70 upon which conductors 66 and 68 are located. Outside the confines of recessed cavity 64, wire 48 also includes an insulator 72 as shown in FIG. 3.

Apart from operation, switch 30 exists more particularly as switch 30a in which the associated electrical circuit is in a normally open state. Then, during operation, switch 30 exists more particularly as switch 30b in which the associated electrical circuit is in a closed state. More specifically, during operation a force F is applied to outer surface 18 of skin layer 26. Force F is ordinary applied by the vehicle occupant through the fingertips. Upon application, force F works on skin layer 26 and housing 52 such that they deform to enable contact portions 60 and 62 of elongated members 54 and 58 of switch arm 50 to contact conductors 66 and 68 of wire 48 and thus close the electrical circuit as created through connecting member 56 of switch arm 50.

As indicated above, within the confines of recessed cavity 64, wire 48 comprises conductors 66 and 68 as well as an insulator 70 upon which conductors 66 and 68 are located. However, as also indicated above, outside the confines of recessed cavity 64, wire 48 also includes an insulator 72 as shown in FIG. 3. It is noted that insulator 72 exists outside the confines to recessed cavity 64 generally to protect conductors 66 and 68 from undesirable short circuits outside the confines of recessed cavity 64. More specifically, conductors 66 and 68 of wire 48 are protected from short circuit by virtue of being encapsulated between insulators 70 and 72.

As can best be seen from FIG. 3, conductors 66 and 68 preferably have a thin cross sectional thickness with a width Wc greater than thickness Tc. More particularly, conductors 66 and 68 comprise an electrically conductive metal, such as copper or similar metal, in the form of a thin foil. Insulators 70 and 72 comprise thin films, preferably polymer films and more preferably urethane polymer films which are laminated about their edges 74 and 78 as well as a central portion 76 located between conductors 66 and 68. The use of one or more conductors with a rectangular shape sandwiched between two polymer films may be referred to as “flat” wire. The use of flat wire, as opposed to traditional round wire with a round conductor, is preferred for at least partially surrounding and embedding wire 48 in the foam layer 24 by virtue if its thinner cross-sectional thickness than traditional round wire.

More particularly, the flat wire 48 may take the form of a flexible printed circuit (FPC). A FPC generally consists of a pair of polymer or resin films with one or more copper, or similar metal, foils sandwiched therebetween. Upon operation, the metal foil generally functions as an electrical circuit routing electric current between one or more connected electrical devices.

In addition to switch 30 and wire 48 being located beneath the outer surface 18 of the switch panel portion 16 of the interior trim panel electrical switch assembly 10, preferably they are at least partially surrounded by and embedded in the foam layer 24 of the soft feel composite 15.

Preferably, prior to being at least partially surrounded and embedded by the foam layer 24, switch 30 is joined to the inner surface 28 of skin layer 26 or to the outer surface 23 of substrate layer 22, but it is recognized that switch 30 may be positioned at any location therebetween. More preferably, switch 30 is joined to the inner surface 28 of skin layer 26 and/or to the outer surface 23 of substrate layer 22, by a double-sided pressure sensitive adhesive tape located therebetween.

As with switch 30, prior to being at least partially surrounded and embedded by the foam layer 24, wire 48 may also be joined to the inner surface 28 of skin layer 26 or to the outer surface 23 of substrate layer 22, but it is recognized that wire 48 may be positioned at any location therebetween. More preferably, wire 48 is joined to the outer surface 23 of substrate layer 22 by a double-sided pressure sensitive adhesive tape located therebetween or mechanical type engagement clips.

In order to at least partially surround and embed the switch 30 and/or wire 48 in foam layer 24, the switch 30 and/or wire 48 are preferably placed in the cavity 40 created between the inner surface 28 of skin layer 26 and the outer surface 23 of substrate layer 22 as shown in FIG. 2 prior to the introduction of the foam layer 24. Then, foam layer 24 is preferably formed by introducing a foam, or more preferably, a foam precursor material into cavity 40. Preferably, the foam precursor is a urethane foam precursor which is introduced using a reaction injection molding process as known in the art. After the urethane foam precursor is introduced, the reactive constituents, a polyol and isocyanate, begin to react and the subsequently created foam material flows within the cavity 40 thus bonding skin layer 26 to substrate layer 22 while at the same time and flowing around and preferably bonding to the exposed surfaces of switch 30 and wire 48.

Alternatively, switch 30 and/or wire 48 may be located in the skin layer 26. For example, the switch 30 may be held in place as skin-casting material is cast around it as more particularly shown in U.S. Pat. No. 5,269,559 assigned to the assignee of the present invention and incorporated herein by reference.

In the embodiment shown in FIGS. 1, 2 and 3, many types of adhesives, including urethanes, etc., may be used to bond the switch 30 or wire 48 to skin layer 26 or substrate 26 of trim panel 14. The adhesives may be applied in any one of a number of forms to include pressure-sensitive backings, hot melts and spray coatings.

While skin layer 26 is preferably formed by casting, skin layer 26 may also be formed by such processes as, including but not limited to, spray coating, blow molding, or thermoformed sheet and then incorporated into the subsequent foam forming process identified above. With regards to more specific skin materials, skin layer 26 may comprise thermoset or thermoplastic polymers. This group includes, but is not limited to, polymers containing vinyl (e.g. polyvinyl chloride (PVC)), urethane (e.g. thermoplastic urethane (TPU)), olefin (e.g. poylpropylene (PP), polyethyelene (PE), thermoplastic olefins (TPO)), and styrene (e.g. acrylonitrile-butadiene-styrene (ABS)). Also while foam layer 24 is preferably joined to skin layer 26 and substrate layer 22 simultaneously by the reaction injection molding process, foam layer 24 may also be joined to skin layer 26 prior to introduction of substrate layer 22 rather than simultaneously as identified above. For example, skin layer 26 and foam layer 24 may be provided as a multi-layer sheet which is subsequently heated and vacuum formed over substrate layer 22.

In the various embodiments, the foam layer preferably has certain molding conditions and physical properties. With regards to molding conditions, the foam layer 24 is preferably molded below 25 PSI (pounds per square inch) molding pressure and more preferably below 15 PSI molding pressure and even more preferably below 10 PSI molding pressure as to reduce any deformation of the FPC during the foam molding process. With regards to measuring the molding pressure, it is noted that molding pressure may be measured at any location within the trim panel 14. With regards to physical properties, the foam layer 24 preferably exhibits the following:

| Property | Test Method | Value |
|---|---|---|
| Density | ASTM-3574-95 | 0.016-0.288 g/cm³ |
| Ultimate Elongation | ASTM-3574-95 | Greater than 10% |

With regards to measuring density, while any suitable test method may be used, the preferred test method is that of ASTM-3574-95, Test A—Density Test. With regards to range of density values, while the preferred value identified above is from 0.016 to 0.288 g/cm.sup.3, more preferably the value is from 0.06 to 0.15 g/cm.sup.3. With regards to the measured value, it is noted that the above values correspond to that of any single specimen (taken from any location within the trim panel 14), either an interior density specimen or a section density specimen as defined in ASTM-3574-95, and not the calculated median of more than one measured specimen. This is in accordance with ASTM-3574-95, paragraph 11.1 which calls for a single specimen to be tested.

With regards to measuring ultimate elongation, while any suitable test method may be used, the preferred test method is that of ASTM-3574-95, Test E—Tension Test. With regards to the range of elongation values, the preferred value identified above is greater than or equal to five percent (5%), more preferably the value is greater than or equal to ten percent (10%), and even more preferably the value is greater than or equal to twenty-five percent (25%) ultimate elongation. With regards to the measured value, it is noted that the above values correspond to that of any single specimen (taken from any location within the trim panel 14), as defined in ASTM-3574-95, and not the calculated median of more than one measured specimen. This is in deviation with ASTM D-3574-95, paragraph 48.1 which calls for three specimens to be tested and the median value to be reported.

A transparent protective coating may be applied to the outer surface 18 of the skin layer 26 and to the indicia 41. The coating is preferably applied as a liquid and is then dried to form a thin durable protective film that keeps the indicia from rubbing off as is described in greater detail in U.S. Pat. No. 5,448,028 assigned to the assignee of the present invention and incorporated herein by reference.

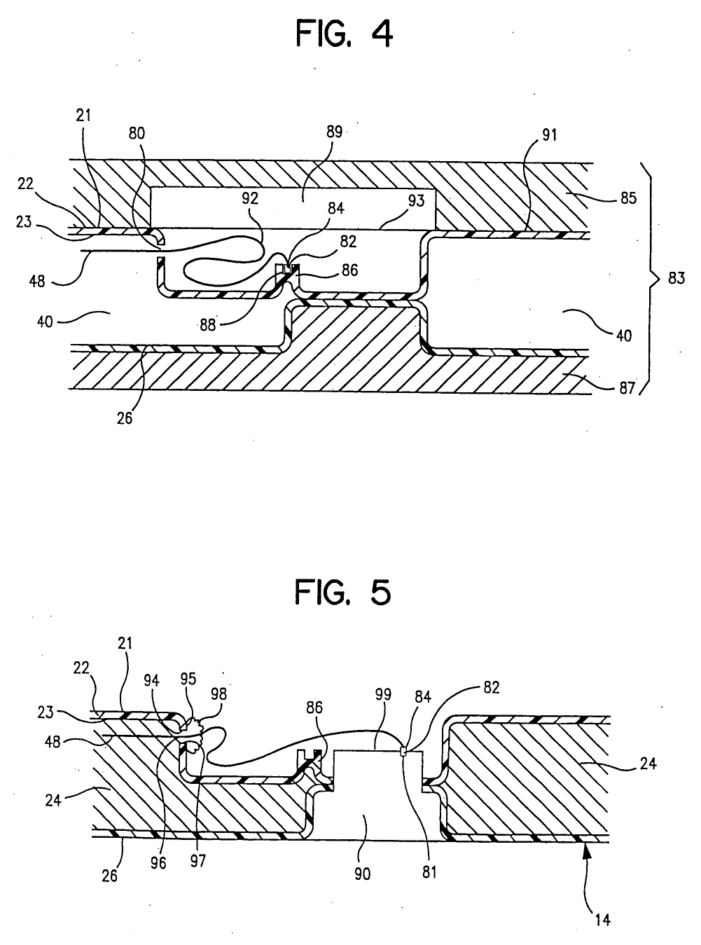

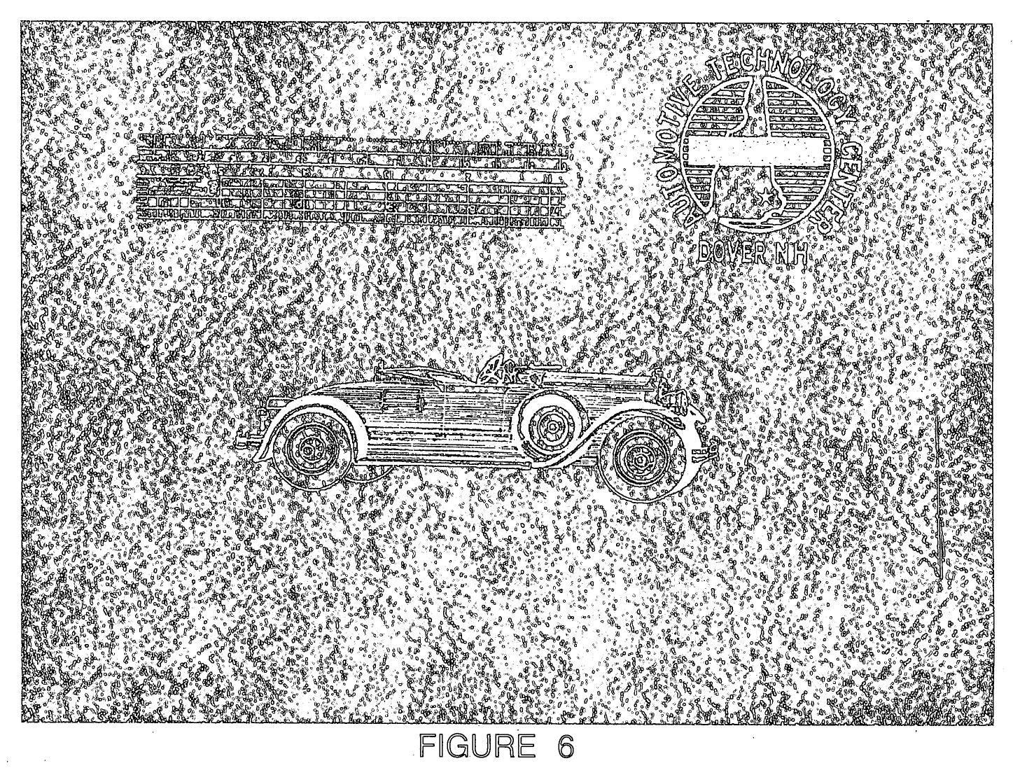

In a second embodiment of the invention, as illustrated in FIGS. 4 and 5, a structure is provided to enable wire 48 to enter and exit the confines of foam layer 24 of trim panel 14. More specifically, prior to being at least partially surrounded and embedded by foam layer 24, wire 48 is routed along outer surface 23 of substrate layer 22 and through aperture 80 to the inner surface 21 of substrate layer 22. Upon placing and introducing skin layer 26 to the substrate layer 22 in a foam mold 83 (shown as first mold part 85 and second mold part 87) in a manner well known in the art, wire 48 now exists in cavity 40 and exits cavity 40 at aperture 80. Aperture 80 is of such a geometry as to permit wire 48 to pass there through. Preferably, aperture 80 is of the geometry of an elongated slot of slightly larger dimension, in both width and thickness, than corresponding width Ww and thickness Tw of wire 48.

Upon passing through aperture 80, terminal end 84 of wire 48 may included a connecter 82 attached thereto. Alternatively, connecter 82 may be attached to the terminal end 84 of wire 48 prior to wire 48 passing through aperture 80, in which case the geometry of aperture 80 must be such as to permit connector 82 as well as wire 48 to pass there through.

Terminal end 84 of wire 48, with or without connector 82, may then be placed into a holder 86 which holds, covers and/or protects from damage the wire 48 or terminal end 84 prior to its designated use. While holder 86 is preferably of temporary use, it is recognized that it may be used for permanent use as in the case where the electrical device 90 to which terminal end 84 of wire 48 is to attach is never installed, possibly due to differences in optional equipment between vehicles.

Preferably holder 86 is formed integral with substrate 22 and is of a geometry, preferably that of an elongated recess 88, of slightly smaller dimension, in either, or both, width and thickness, than terminal end 84 of wire 48. In such a manner, terminal end 84 of wire 14 preferably interference fits with recess 88 of holder 86. As a result, terminal end 84 of wire 48 is retained in recess 88 of holder 86 prior to designated use. In other embodiments, holder 86 may be any device which holds terminal end 84 and/or wire 48 in a confined, and preferably fixed, position prior to designated use. Example of such holders include, but are not limited to tape, adhesives, separate mechanical fasteners (e.g. screws, clips, etc.), or other structures designed integral with substrate 22 (e.g. rib structures, doghouses, etc.).

With the introduction of substrate 22 to first mold part 85 of foam mold 83, a pocket 89 must exist between the inner surface 21 of substrate 22 and the mold surface 91 of first mold part 85 for wire 48 and/or terminal end 84 to exist therein. The pocket 89 may be of any suitable geometry to contain wire 48 and/or terminal end 84 without their damage during the foaming process. As shown, pocket 89 comprises a recess in substrate 22 which includes a location for wire 48, terminal end 84 and electrical device 90. Pocket 89 also is shown to comprise a recess in first mold part 85. It is recognized that any number of geometries may be employed to facilitate the presence of wire 48 and/or terminal end 84 adjacent the inner surface 21 of substrate 22 during the foaming process. The length of wire 48 required to extend wire 48 between aperture 80 and holder 86 may be different than is required to extend wire 48 between aperture 80 and receptacle 81 of electrical device 90. In the case where the length of wire 48 required to extend between aperture 80 and holder 86 is less than the length of wire 48 required to extend wire 48 between aperture 80 and receptacle 81 of electrical device 90, wire 48 may be comprise one or more rolls, bends, or folds 92 which exist while terminal end 84 of wire 48 is retained in holder 86. These rolls, bends, or folds may then be reduced in size or number when terminal end 84 of wire 48 is attached to receptacle 81 of electrical device 90. As used herein, an electrical device 90 is any electrical device, active or passive, electrical or electromechanical, which consumes, generates, or otherwise manipulates electrical power. This includes, but is not limited to, electrical motors, electromechanical motors, circuit boards, switches, power sources, couplers, sensors, junction boxes and fuse panels. As shown in FIG. 1, electrical device 90 is a seat switch.

A second example of a holder 86 which holds terminal end 84 and wire 48 in a confined position prior to use is tape 93. Tape 93 may cover the recess in substrate 22 such that, should the terminal end 84 become dislodged from recess 88 of holder 86 or folded wire 48 attempt to unfold from pocket 89 prior to use, the terminal end 84 and/or wire 48 will be prevented from exiting the confines of the recess in the substrate 22.

During the foam process in which foam material flows within cavity 40 thus bonding skin layer 26 to substrate layer 22, preferably foam layer 24 extends into the confines of aperture 80 and exists between surfaces 94 and 96 of substrate 22 with wire 48 located therebetween. In this manner, foam layer 24 acts as a buffer between wire 48 and surfaces 94 and 96 of substrate 22 as to reduce, and preferably prevent, wire 48 from making contact with surfaces 94 and 96 of substrate 22. As a result, the possibility of undesirable noise created by wire 48 rubbing against either surface 94 or 96 of substrate 22 during vehicle movement is substantially reduced. Further, the possibility of an undesirable short circuit caused by insulators 70 or 72 of wire 48 rubbing against either surface 94 or 96 of substrate 22 and wearing to expose the conductors located therebetween is also reduced.

In order to reduce the amount of foam material exiting from aperture 80 as a result of the foam process, a layer of tape or other type of seal (not shown) may be applied to inner surface 21 of substrate 22 to partially close aperture 80. Foam material which exits the aperture may do so in the form of a bun 98. The bun 98 preferably at least partially surrounds and bonds to a portion of the wire 48 which has exited aperture 80. In this manner, the foam bun 96 may act as a stay to help prevent wire 48 which has been at least partially surrounded and embedded by foam layer 24 from being inadvertently displaced from its embedded position by virtue of being partially or completely pulled out through aperture 80, thus damaging the trim panel 14. The bun 96 may also reduce, and preferably prevent, wire 48 from making contact with corners 95 and 97 of substrate 22 which may act to cut or otherwise damage the wire 48 depending on their sharpness.

While bun 98 may be used for the above benefits, depending on the size of the bun 98, it may be partially or completely removed from trim panel 14 after the foaming process. If aperture 80 is to large, the size of the resulting bun 98 may surround and embed a substantial portion of wire 48 such that at least a portion of the bun 98 must be removed. That portion of the bun 98 removed is generally preformed prior to attachment of wire 48 to receptacle 81 of electrical device 90 and often is preformed to facilitate extending wire 48 in order to attach wire 48 to receptacle 81 of electrical device 90. Since the foam material is of a low density and generally flexible or semi-rigid by virtue of its cushion or padding effect, it ordinarily may be removed manually, with and/or without the use of hand operated tools. However, where removal of the bun 98 to the wire 48 or the inner surface 21 of substrate 22 is to be made easier, a mold release may be applied, generally by brush or spray, to wire 48 and inner surface 21 of substrate 22 after wire 48 has passed through aperture 80 and prior to the foaming process.

After removal from the foam mold 83, opening 99 is formed in trim panel 14 to facilitate that attachment of electrical device 90 to trim panel 14. Preferably after electrical device 90 is attached to trim panel 14, but possibly before, terminal end 84 of wire 48 is removed from its confined position (i.e. first position) and attached to receptacle 81 of electrical device 90 (i.e. second position).

Indicia 41 in the form of letters, numbers, or symbols may be printed, such as with silk screening, or molded on outer surface 18 of the skin layer 26 to indicate to vehicle occupants the position and/or function of each switch 30 or switch array 20 as shown in FIGS. 1 and 2. As an alternative to or used in combination with printing and/or molding, a laser, and more preferably a YAG laser, may be used to change the color (e.g. bleach or whiten) of the material, and preferably the pigments, of skin layer 26 as to create markings in the outer surface 18 which indicate to vehicle occupants the position and/or function of each switch 30 or switch array 20 as shown in FIGS. 1 and 2.

Accordingly, in broad embodiment, it has been found that a laser can be projected onto the surface of an automotive trim component and manipulated to provide decorative features in the form of a color change of the surface, or to create a design or decoration by ablation or thermal decomposition, or by a combination of color change and engraving of the component surface. Thus, automotive trim components, for interior, exterior and underhood applications, having decorative surface features, both in color and of three dimensions, can be prepared by using a laser projected onto the surface. In such context, plastic skin materials, or portions thereof such as formed stitches or accent lines, may be decorated by laser without the need for special additives. In addition, the present invention serves to provide laser marking of painted automotive trim components by removing the paint coating locally to expose the color beneath the paint. In addition, the present invention provides automotive trim components with personalized designs for the vehicle owner created by a laser projected onto the component surface. Furthermore, in broad embodiment, this invention provides top surface engraving of an air bag door cover to act as a preweakened tear seam. This weakening seam may or may not be in the shape of a decoration.

Laser beams projected on a polymer surface may provide a number of useful features depending on the type and power level of the laser and polymer employed. With laser radiation of short wavelength (short infrared, YAG or UV excimer), a dissociation of molecules where the surface is irradiated may result in a color change. At low laser intensities, a destruction of molecular structure may cause a color change and foaming. A modified surface structure in the form of a hole or a groove or etch can be achieved using a far-infrared CO₂ laser which thermally decomposes or vaporizes the surface. At high laser intensities, the local surface may be evaporated leaving a hole or a groove or etch and as a result of carbonization, a color change also may occur.

According to another embodiment of the present invention, an 0.040″ thick cast sheet of thermoplastic urethane (TPU) of a composition such as is disclosed in U.S. Pat. No. 6,187,859, which is assigned to the assignee of the present invention and incorporated herein by reference, was exposed to a Starmark 65, YAG laser, (A B Laser/Rofin-Sinar) operating at 2 KHz frequency and 13 amps with a printing speed of 12 inches/sec. The TPU composition contained a standard automotive grade pigmentation package comprising carbon black, titanium oxide, red iron oxide and yellow chromathol totaling a 2% by weight loading which when cast yielded a grained sheet which was medium brown in color. As shown in FIG. 6, a series of images were scanned into the laser computer memory and the program initiated to project the laser beam into the sheet surface, moving the laser mirrors to irradiate the sheet surface with the images shown. A rich bronze image was produced on the surface of the sheet in the shapes of a company logo, an antique vehicle and a measuring scale. Exposure of the decorated sheet to 601 Kilojoules of accelerated Xenon weathering per SAE J1885 showed no bleaching of the decorative images.

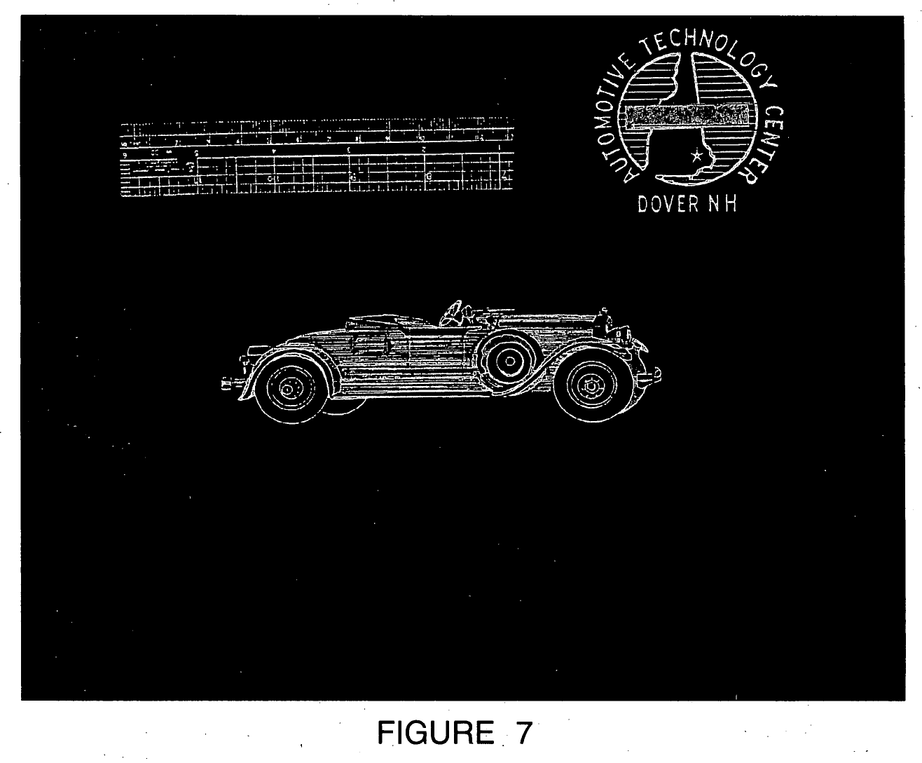

In still another embodiment, an 0.125″ thick smooth sheet was formed from a polycarbonate/acrylonitrile-butadiene-styrene alloy composition. The sheet was exposed to the same Starmark 65 laser but using a frequency of 3 KHz and a current of 10 amps. The sheet was pigmented to an automotive grade black color. FIG. 7 shows the results obtained. A light gray colored image was produced on the surface of the sheet in the shapes of a company logo, an antique vehicle and a measuring scale which contrasted nicely with the black background.

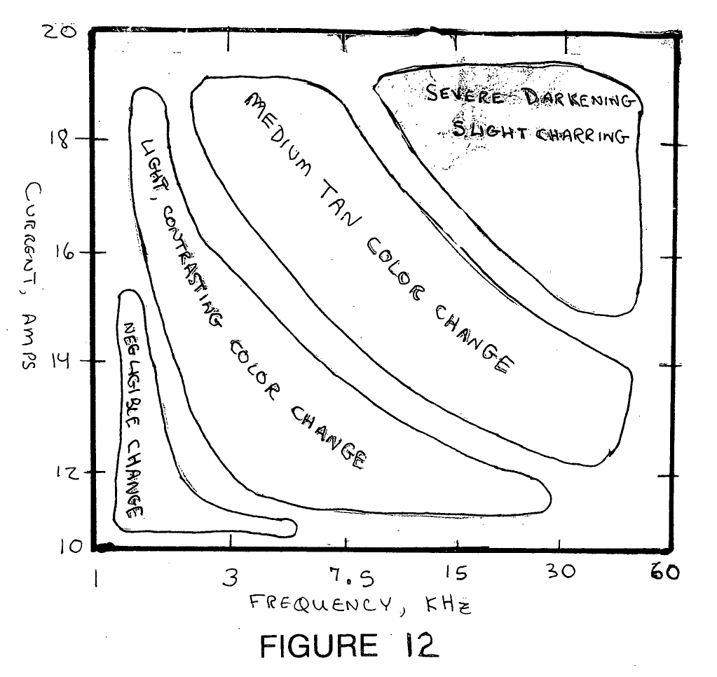

As shown in FIG. 12, a grid of amperage vs. frequency was produced using a PVC alloy sheet to demonstrate the potential for achieving different shades of color change by varying laser parameters. Results varied from no noticeable color change at low amperage (10) and frequency (1 KHz) to a dark brown charring of the surface at high frequency (30 KHz) with high amperage (19).

While cast sheet stock was the primary choice for decoration in these embodiments, other plastic conversion processes known to those skilled in the art may be used to create automotive components for decoration, such as, but not limited to, injection molding, blow molding, rotational casting, thermoforming, compression molding, etc. In addition, any thermoplastic or thermosetting resin may be suitable for laser decoration including but not limited to polyesters, polystyrene, high impact polystyrene, styrene-butadiene copolymers, impact modified styrene-butadiene copolymer, poly-\acute{α}-methyl styrene, styrene acrylonitrile copolymers, acrylonitrile-butadiene-styrene, acrylonitrile butadiene copolymers, polyisobutylene, polyvinyl chloride, polyvinylidene chloride, polyvinyl acetals, polyacrylonitrile, polyacrylates, polymethacrylates, polybutadiene, ethylene-vinyl acetate, polyamides, polyimides, polyoxymethylene, polysulfones, polyphenylene sulfide, polyvinyl esters, melamines, vinyl esters, epoxies, polycarbonates, polyurethanes, polyether sulfones, polyacetals, phenolics, polyester carbonate, polyethers polyethylene terephthalate, polybutylene terephthalate, polyarylates, polypropylene sulfides, polyether ketones, polyethylene, high density polyethylene, polypropylene, thermoplastic elastomers (TPE), thermoplastic olefins (TPO) thermoplastic rubber (TPR) and copolymers, grafts, blends, alloys and mixtures thereof.

Somewhat unexpectedly, the images formed in the above embodiments were produced in a pleasing contrasting color to the base pigmentation without the need for special additives or energy-absorbing pigments.

In a further embodiment, plastic sheet stock was treated using a laser to form a pattern of holes part-way through the thickness of the sheet to differentiate the surface appearance and to provide an entirely unique texture resembling woven fabric. The holes are preferably arranged on and across the surface of the sheet stock to be viewed by the consumer, in the “x” and “y” direction (the “z” direction corresponding to stock thickness) to thereby create the desired surface texture appearance. In such manner, those skilled in the art will appreciate that any desired surface texture appearance can now be targeted to any location on the sheet stock or other molded article to create the impression that a portion of the plastic sheet stock or article, at a desired location, is not molded plastic, but is of a woven fabric material. In such manner, the invention herein provides an article comprising plastic material wherein the texture appearance of the article may be different at any location on the article by the adjustment of hole pattern, size, distribution and alignment as disclosed herein.

Preferably, the depth of the holes therein, i.e., the value of the hole depth “z” is up to about 50% of the thickness of the material being marked. In addition, preferably, the holes in either the “x” or the “y” direction form a plurality of rows of holes, and in the broad context of this invention, it has been found that when the number of rows for the holes in the “x” and “y” direction is preferably at least 10, a region of the plastic article remarkably assumes the appearance of a woven fabric. The advantage of such a visual modification to the surface of e.g., plastic sheet stock or other molded articles to provide a woven fabric appearance cannot be understated. Specifically, the invention herein now provides the appearance of an expensive, woven fabric finish for an automotive trim component, based upon the use of far less expensive cast or formed materials.

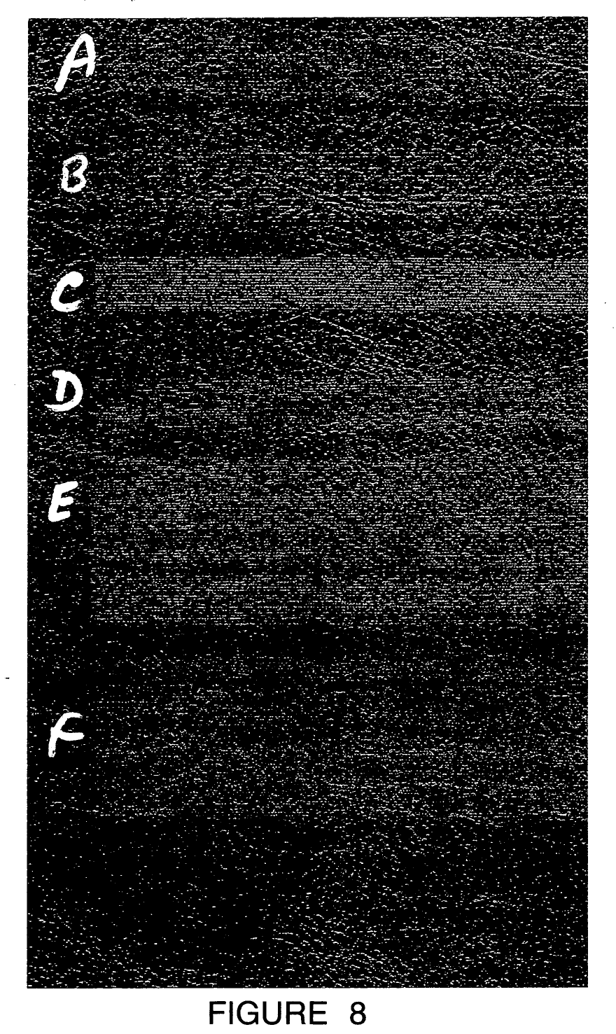

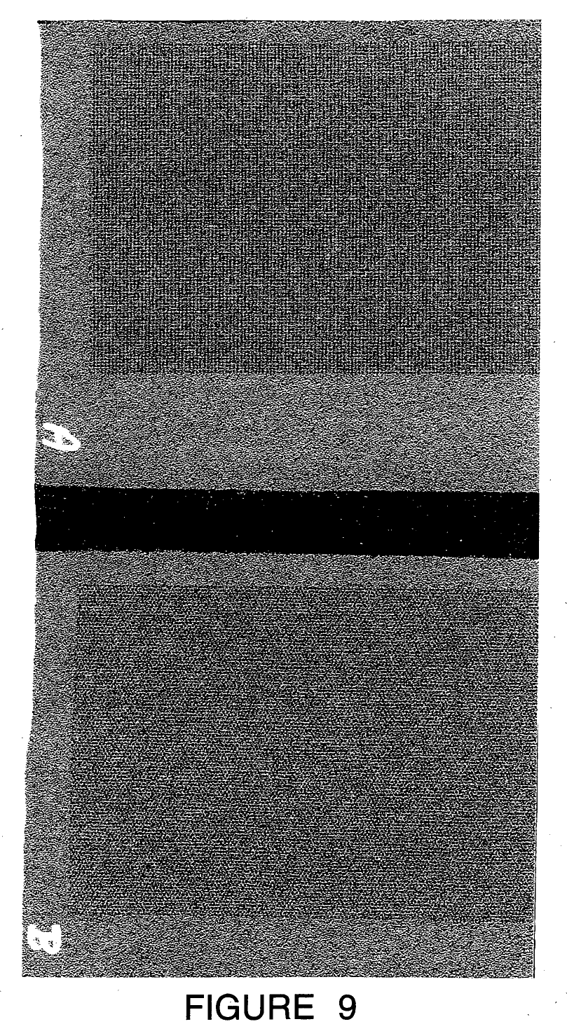

FIG. 8 illustrates a series of hole patterns, A through E, incorporated into the surface of a cast sheet of thermoplastic olefin (TPO) to provide a needle-punched fabric appearance, although in the broad context of the present invention, other polymer materials as noted herein would suffice. The TPO was a gray colored grained sheet, 0.050″ thick, cast from a commercially available TPO powder. The holes were created with a Diamond 64 CO₂ laser from Convergent Energy, Inc. operating at a wavelength of 10.6 micrometers. The movement of the sheet under the laser was at least 3.5 inches per second and the beam focusing lens had a 5.0 inch focal length. This provided holes having diameters from about 0.0165″ to about 0.0200″ depending on the pulse width chosen (see Table I).

Pattern C in FIG. 8 illustrates a series of holes incorporated into the thermoplastic olefin (TPO) noted above, to provide a more contrasting needle-punched fabric appearance. In this example, the hole diameter was about 0.0165″. The hole depth was greater due to the higher pulse width used and the holes were staggered in rows.

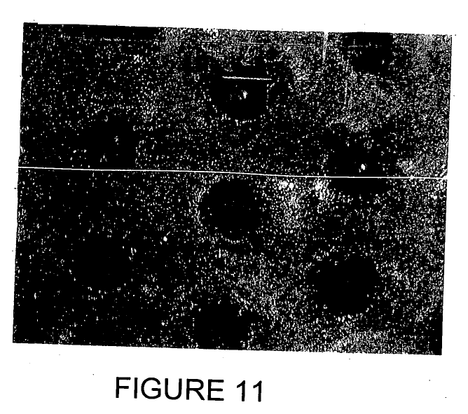

FIG. 11 is a photograph of a magnification of pattern C of Table I. The conditions to produce the hole patterns and sizes in FIG. 8 are listed in Table I. The hole diameters are about one-fourth of the hole spacings (about 0.01″)

TABLE I

| | No. of Lines | Pulse | Hole | | |
|---|---|---|---|---|---|
| Decoration | of Holes | Width | Spacing | Defocus | Pattern |
| A | 10 | 100 | 0.04 | 0.2 | square |
| B | 20 | 100 | 0.04 | 0.2 | staggered |
| C | 20 | 300 | 0.04 | 0.2 | staggered |
| D | 40 | 200 | 0.03 | in focus | staggered |
| E | 30 | 150 | 0.03 | in focus | staggered |
| | | | | | (2.5″ focus |
| | | | | | length lens) |

As may be seen in FIG. 8, the hole patterns appear as a needle-punched surface and substantially change the gloss and color appearance of the surface of the sheet. In the case of pattern E in FIG. 8, a wave-like undulating appearance was developed by varying the focal length of the laser lens.

FIG. 9 illustrates a different surface appearance formed on the surface of a sheet. In this instance, a burnished, tightly woven, almost linen-like fabric appearance was achieved on the surface of a PVC/chlorinated polyethylene alloy sheet using a Diamond 64 CO₂ laser. Using the conditions set forth in Table 1, patterns A and B, the examples in FIG. 9, A and B, respectively, were created. The PVC alloy was tinted light gray and coated with 0.0005″ of a commercial urethane black paint used on interior trim components. The hole diameter created was about 0.0142″ and a linen-like appearance obtained due to the effect of the laser on the PVC alloy material. Other plastics may yield other surface effects as noted with the TPO in FIG. 8.

In addition, when the pulse rate of the laser was increased, a line or groove rather than a hole resulted which was then programmed to be a logo or emblem or identifying mark. That line or decorative feature if placed on an airbag cover may additionally function as a tear seam, but a visible rather than hidden seam.

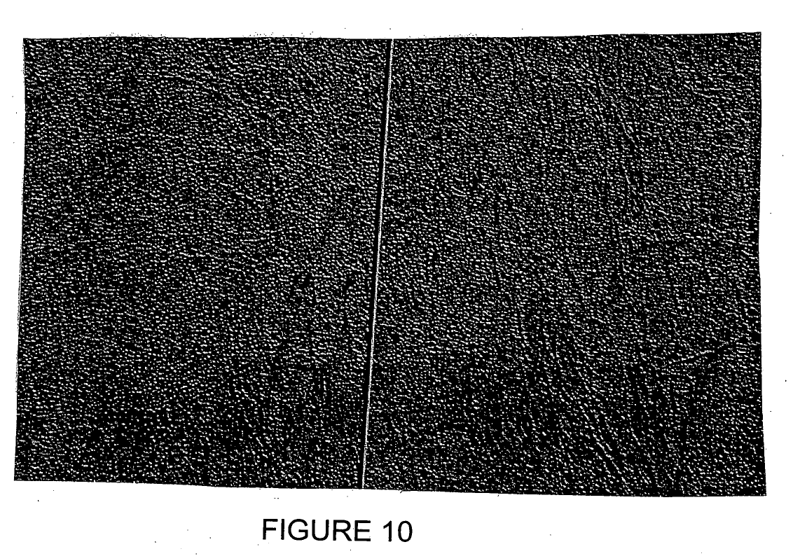

FIG. 10 illustrates such a feature. In this instance an 0.040″ thick grained sheet of thermoplastic olefin (TPO) from Haartz, Corp. was knife-scored using a USS40 ultrasonic machine from American GFM. The TPO was a light tan 0.040″ thick vacuum formable sheet stock. The US40.50.196 V-groove blade was set up to leave 0.020″ remaining after scoring. The blade operated at ambient, at a frequency of 35 KHz and 90% amplitude (of 0.005″ stroke). The rate of travel of the knife was 100 inches/min. In this instance, a straight cut was made as an evaluation for a visible airbag cover tear seam. The same device may be used to form decorative features in the plastic part surface as well by changing the program parameters.

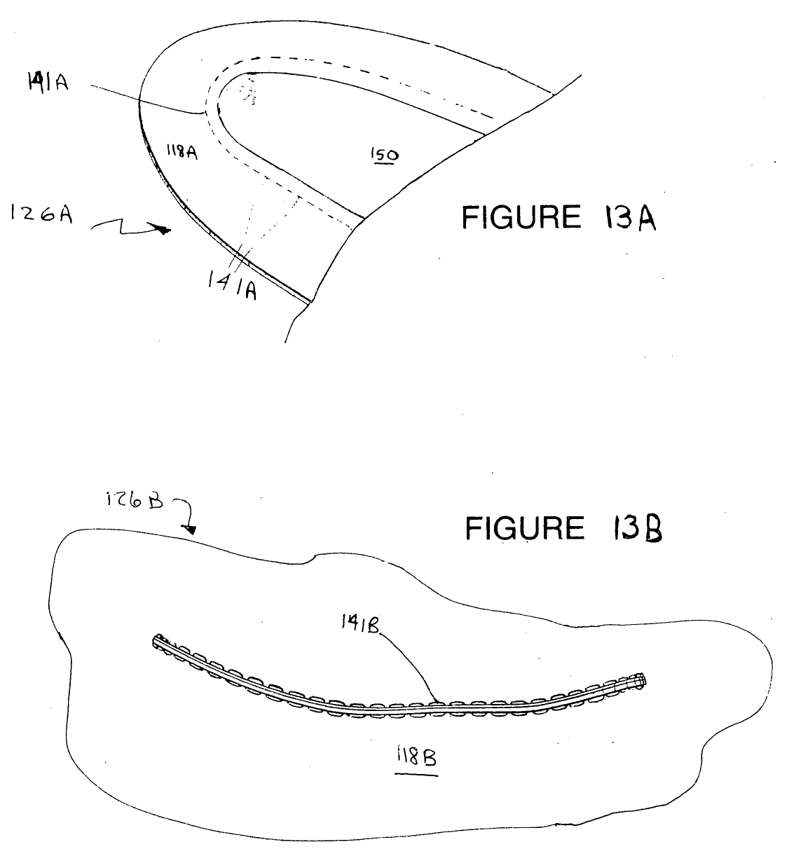

FIGS. 13A and 13B illustrate an additional embodiment wherein a plastic component has been formed by, for instance, but not limited to, a process of casting, vacuum forming, injection molding, and the like. The surface includes a series of imitation stitches, 141A, 141B. Using the present invention, a laser may be directed precisely at only the imitation stitches 141A, 141B and the plastic which forms the stitches may be changed in color to a contrasting color by the radiation from the laser. Thus, the imitation stitches 141A, 141B will appear more real and will be distinguished from the surrounding surface 118A, 11B by the contrast in color. Alternatively, the color of the stitches 141A, 141B or any other feature formed by the present invention may be of a complementary color rather than a contrasting color. FIG. 13A illustrates the sail area of a door panel for a vehicle wherein a center insert 150 may be of fabric or cloth and the surrounding surface comprises a plastic surface 118A upon which protrusions which appear as stitches 141A have been formed. The stitches when irradiated by a laser may be changed to a different color than the surrounding surface. FIG. 13B illustrates an alternative stitch design such as for the surface 118B of a vehicle armrest or instrument panel (or other interior trim component) 126B. Here, the raised nstitches 141B have been exposed to a laser beam to change the color of the raised surface of the stitches 141B to be different than the color of the surrounding surface 118B.

Thus, it can be seen that the present invention provides a new and improved method for decorating automotive trim and underhood components by using a laser to change the color of or to engrave a pattern into the surface of these components. Additionally, components are produced than can be personalized, be tagged or used to provide information to a vehicle occupant.

We intend the above description to illustrate embodiments of the present invention by using descriptive rather than limiting words. Obviously, there are many ways that one might modify these embodiments while remaining within the scope of the claims. In other words, there are many other ways that one may practice the present invention without exceeding the scope of the claims herein.

What is claimed is:

1. A laser-marked molded, extruded or formed plastic article having a thickness and a viewing surface, the article comprising holes or lines part-way through the thickness of the article from the viewing surface, said holes located in both an “x” and “y” direction on said viewing surface, said holes having a depth “z” of up to about 50% of the thickness wherein said pattern of holes in the “x” and “y” direction each comprise two or more rows of holes, and said holes having a diameter of from 0.0100″ to 0.0300″ at the viewing surface.

2. The plastic article claim 1 wherein said line forms a decoration of the viewing surface.

3. The plastic article of claim 1 wherein said decoration comprises an engraving of said article surface.

4. The plastic article of claim 3 wherein said engraving comprises a tear seam for an airbag cover, the seam on the surface of said article.

5. The plastic article of claim 3 wherein said decoration comprises an engraving of said article surface with one of a laser or ultrasonic knife.

6. The plastic article of claim 1 wherein said articles are formed by injection molding, extrusion, blow-molding, powder casting, thermoforming, rotational casting, compression molding, liquid casting, reaction injection molding and resin transfer molding.

7. The plastic article of claim 1 wherein said articles comprise polyesters, polystyrene, high impact polystyrene, styrene-butadiene copolymers, impact modified styrene-butadiene copolymer, poly-a-methyl styrene, styrene acrylonitrile copolymers, acrylonitrile-butadiene-styrene, acrylonitrile butadiene copolymers, polyisobutylene, polyvinyle chloride, polyvinylidene chloride, polyvinyl acetals, polyacrylonitrile, polyacrylates, polymethacrylates, polybutadiene, ethylene-vinyl acetate, polyamides, polyimides, polyoxymethylene, polysulfones, polyphenylene sulfide, polyvinyl esters, melamines, vinyl esters, epoxies, polycarbonates, polyurethanes, polyether sulfones, polyacetals, phenolics, polyester carbonate, polyethers polyethylene terephthalate, polybutylene terephthalate, polyarylates, polypropylene sulfides, polyether ketones, polyethylene, high density polyethylene, polypropylene, thermoplastic elastomers (TPE), thermoplastic olefins (TPO) thermoplastic rubber (TPR) and copolymers, grafts, blends, alloys and mixtures thereof.

8. The plastic article of claim 1 wherein said decoration is used for personalization, tracking, identification or instructional purposes.

9. The plastic article of claim 1 comprising a layer of paint covering the surface of said article wherein the layer of paint is a different color from the surface of said article and wherein a laser is projected on the paint layer to remove said layer in a decorative pattern exposing the article surface of a different color.

10. A plastic interior trim panel having a surface upon which one or more imitation stitches or one or more accent lines are formed, said surface of a first color,
wherein one or more of said stitches or accent lines are colored a second color different from the surface of said article by the irradiation of a laser upon said stitches or accent lines.

11. A method of coloring imitation stitches or accent lines formed on the surface of an interior panel, comprising the steps of;
forming the interior panel including a surface, wherein imitation stitches or accent lines are formed on the surface;
irradiating one or more of the stitches or one of more of the accent lines with a laser to change the color of said stitches.
